(19) United States
(12) Patent Application Publication
(10) Pub. No.: US 2004/0091312 A1
(43) Pub. Date: May 13, 2004

(54) Apparatus for reducing stress in a mounting plate

(75) Inventors: Hall Virgil JR., Brownsburg, IN (US); Merle D. Sears, Mooresville, IN (US); Michael L. Brown, Greenwood, IN (US)

Correspondence Address: WALL MARJAMA & BILINSKI, 101 SOUTH SALINA STREET, SUITE 400, SYRACUSE, NY, 13202, US

(73) Assignee: Carrier Corporation

(21) Appl. No.: 10/293,725

(22) Filed: Nov. 13, 2002

(51) Int. Cl. F16D 1/00

(52) U.S. Cl. 403/408.1

(57) ABSTRACT

Apparatus for mounting one or more component parts of a unit in assembly. The apparatus includes a mounting plate containing one or more extruded holes each having a raised lip surrounding the hole which protrudes upwardly from the top surface of the plate for receiving a threaded fastener that is used to secure a part to the bottom mounting surface of the plate. An endless depression surrounds each hole which also protrudes outwardly from the top surface of the plate. The size and shape of the depression is such that the plate area surrounding the fastener receiving hole is strong enough to resist high impact loads.

### FIELD OF THE INVENTION

This invention relates generally to an improved mounting plate to which articles are secured by threaded fasteners which has improved impact load resistance properties.

### BACKGROUND OF THE INVENTION

Typically articles such as motor driven blower wheels and the like are secured in assembly to a mounting plate. In many cases the plate is fabricated of sheet metal and the article or articles are held to the plate by screws that are threaded into extruded holes formed in the plate. When the assembly is submitted to an impact loading, the resulting forces can be high enough to cause the screws to pull out of the plate thereby rupturing the plate. This type of failure generally produces a jagged tear in the plate that render the plate unsuitable for its intended use. Impact failure generally occurs during times when the goods are in transit. The impact stress developed during shipment generally acts along the axis of the screws holding the article to the mounting plate. When the stress exceeds the yield stress of the plate material, the screw pulls out of the plate ripping the material in and around the screw hole area.

### SUMMARY OF THE INVENTION

It is an object of the present invention to improve mounting plates that utilize fasteners that are threaded directly into the plate for the purpose of securing articles thereto.

It is a further object of the present invention to prevent the failure of a mounting plate used to mount parts in an assembled unit in which the parts are secured to the plate by fasteners that are threaded directly into the plate.

A still further object of the present invention is to improve the impact resistance of a mounting plate having extruded holes for mating with threaded fasteners used to secure articles to the plate.

It is an object of the present invention to reduce the material gauge needed to provide adequate support and function.

These and other objects of the present invention are attained by apparatus for mounting one or more component parts to a multi-component unit. The apparatus includes a mounting plate having one or more holes extruded therein for threadably receiving screws or the like that are used to secure an article or articles to the plate. The plate has a flat top mounting surface and an opposed bottom surface. The extruded holes are provided with a lip that protrudes upwardly from the top surface of the plate and are arranged to threadably engage threaded fasteners such as screws and the like. Endless depressions are stamped into the plate which surround the holes. The depressions also protrude outwardly from the bottom surface of the plate and are preferably circular in form and have a cross section that is arcuate. The size and shape of the depressions are such that the plate area around the fasteners are strong enough to resist impact loads that are greater than the yield strength of the plate material.

### BRIEF DESCRIPTION OF THE DRAWING

For a further understanding of the present invention reference will be made to the detailed description of the invention below which is to be read in association with the accompanying drawing, wherein:

FIG. 1 is an exploded view in perspective of a prior art mounting plate showing the results of plate failure due to high impact loading incurred while the goods are in transit; and

FIG. 2 is a sectional view showing a mounting plate embodying the teachings of the present invention.

### DETAILED OF THE INVENTION

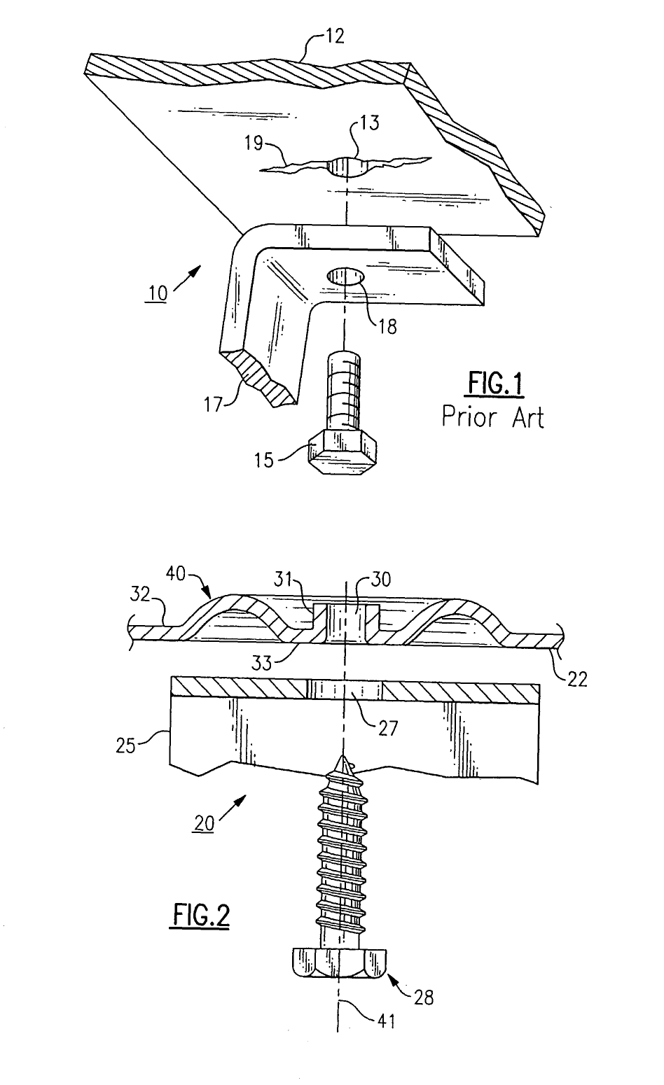

Referring initially to FIG. 1 there is illustrated an exploded view in perspective showing a mounting arrangement 10 used in the prior art for securing component part of a unit in assembly. In this arrangement, a mounting plate 12 is provided with a series of holes, such as hole 13, that is punched or extruded in the plate for threadably engaging screws 15 or the like. The mounting plate typically is fabricated from a steel sheet having a yield stress of about 30,000 psi. The component part is secured to one surface of the plate using mounting flanges 17 having clearance holes 18 formed therein. Screws 15 are passed through the clearance holes and are threaded directly into the receiving holes formed in the plate. In assembly, the screws are tightened down to hold the flanges tightly against the mounting surface of the plate.

This type of mounting found in the prior art is generally acceptable for use in situations where the unit is exposed to low impact loads. Tests have shown, however, that this type of mounting structure is often times exposed to higher than previously realized impact stresses when the goods are in transit. This type of induced loading can act along the axis of the threaded fastener and reach levels higher than the yield stress of the mounting plate material. When this occurs, the fasteners are pulled or pushed out of the receiving holes deforming or otherwise tearing the material about the hole leaving behind a jagged opening 19 necessitating replacement of the mounting plate and potentially endangering the parts mounted thereon.

Turning now to FIG. 2, there is shown apparatus for securing a blower assembly generally referenced 20 utilized in a home heating furnace to a shelf 22 located in the furnace housing. Typically, this type of shelf is fabricated from a sheet of 20 gage steel plate having sufficient strength to safely support this type of equipment during normal furnace operations. However, as noted above, this type of equipment can be subjected to high impact forces during shipment due to harsh handling or rough traveling conditions. Under certain conditions the stress can reach a high enough level such that the fasteners are pulled out of the support shelf and the goods damaged while in transit. Although, the present invention is described with specific reference to a support shelf, it should be evident that the support need not be a shelf and can be a simple sheet metal plate.

With specific reference to FIG. 2, the blower assembly is equipped with a series of mounting flanges 25 each having a clearance hole 27 through which the shank of a threaded fastener such as hex headed self tapping screw 28 can pass. The mounting flanges are each seated at a desired location on the bottom surface of the shelf over a hole 30, that is arranged to receive the self tapping fastener.

Any type of suitable hole that is known and used for this or similar purposes may be utilized in the practice of the invention and may include drilled, cored and punched holes as well as hand punched holes and extruded holes. An extruded hole is shown in FIG. 2 for illustrative purposes. Accordingly, the screw upon entering the hole can be tightened down to secure the mounting flange to the shelf.

A circular depression 40 is stamped into the support shelf or plate so that the depression surrounds the mounting hole. The depression can take any type of endless shape with a circular shape being preferred. As best illustrated in FIG. 2, the depression is generally arcuate in cross-section and extends upwardly from the top surface 32 of the shelf. A flat hub section 33 separates the depression from the hole, the hub being in coplanar alignment with the plate. Stress analysis tests conducted on support structures having ripple like depressions as described above have shown to considerably reduce impact stresses around the hole. Further testing found that the radius and depth of the depression could be optimized without too much difficulty such that the maximum stress about the hole can be reduced to a value below the yield stress of the shelf or support plate material. Prototype support plates having the above described ripple configuration surrounding a mounting hole were transit tested under adverse conditions without incurring any incident of plate failures.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. Apparatus for mounting parts to an assembly that includes:
a mounting plate having a flat top surface and a bottom surface;
at least one hole passing through said plate for receiving a threaded fastener;
an endless depression formed in said plate that surrounds said hole, said depression protruding upwardly from the top surface of the plate; and
said depression having a size and a shape such that the magnitude of stresses resulting from impact loads about the said at least one hole are reduced to a level below the yield strength of the plate.

2. The apparatus of claim 1 wherein said depression is circular and is centered upon the center of said hole.

3. The apparatus of claim 2 wherein said depression is arcuate in cross section.

4. The apparatus of claim 1 wherein said plate is fabricated of sheet metal and the threaded fastener is a self tapping or thread forming screw.

5. The apparatus of claim 1 that further includes a plurality of holes, each hole being surrounded by an endless depression.

6. The apparatus of claim 1 that further includes a flat section of plates separating the depression and the at least one hole.
